(19) United States
(12) Patent Application Publication
(10) Pub. No.: US 2026/0167466 A1
(43) Pub. Date: Jun. 18, 2026

(54) Device for Cable Guide Pulley

(71) Applicant: Philippe SOUYRI

(72) Inventor: Philippe SOUYRI

(21) Appl. No.: 18/707,870

(22) PCT Filed: Oct. 25, 2022
(86) PCT No.: PCT/FR2022/052024

§ 371 Date: May 6, 2024

(51) Int. Cl. B66D 3/04

(52) U.S. Cl. CPC B66D 3/04

(57) ABSTRACT

A device which is designed to form a lining of a cable guide pulley, the device having an exterior face provided with a groove which is designed to be in contact with a cable, the device having a thickness (t), the device comprising at least 2 volumes, i.e. an exterior volume which is exposed at the exterior face and contains the groove, and a main volume which is exposed at the interior face, a modulus of elongation MA10 of an elastomer composition constituting the exterior volume being lower than the modulus of elongation MA10 of an elastomer composition constituting the main volume, and a radial thickness (to) of the exterior volume measured at the axial centre of the groove being less than 0.5 times the thickness (t) of the device.

The present invention relates to a device for a cable guide pulley. The invention relates in particular to a device which is designed to form a lining of the cable guide pulley.

A device, and a cable guide pulley to which the present invention relates, are objects habitually described by a representation on a meridian plane, i.e. a plane containing an axis of rotation of the cable guide pulley. All of these products (the device and the cable guide pulley) are objects which have a geometry of revolution relative to their axis of rotation.

Systems for transport by cable normally comprise a traction cable extending along a given path; at least one transport unit which is mobile along the path, and can be connected to the traction cable by a coupling device; a support structure which is placed along the path in order to support and guide the transport unit; and at least one cable guide pulley installed on the support structure. Systems for transport by cable of the above type comprise both systems on rails and suspended systems.

The cable guide pulley is provided with a device (lining), also known as an “envelope” or “strip”, which is designed to be in direct contact with the traction cable. The device (lining) is mainly composed, with the exception of an interior end part of the device (lining) which is designed to be in contact with an exterior surface of the cable guide pulley (a sole layer), of a single elastomer composition, for better adhesion with the traction cable, and in order to absorb the vibrations generated by means of the traction cable and/or the support structure, which vibrations are transmitted by the traction cable, while withstanding the mechanical attack of the traction cable which gives rise to the generation of cracks on a surface of the device (lining) as a result of mechanical fatigue.

In order to improve functions of this type of the device (lining), it is known that rigidification of the device (lining) is efficient, in particular for the resistance to mechanical attack of the traction cable. Various solutions have been proposed in order to improve these functions.

Document EP0194948 describes a stress distribution device which is designed to form the device (lining) of a cable guide pulley in an overhead transport system, the device (lining) comprises at least two layers of resiliently deformable materials with decreasing hardness, with a layer in contact with the cable being made of an anti-abrasive material with Shore hardness of more than 60, and an under-layer in contact with the groove of the pulley being made of a flexible, resilient material with Shore hardness of the 70 at the most.

Document DE202015006091 describes a tire for a cable pulley, in particular in a cable drive pulley or a cable guide roller, for means for transport by cable of people or materials, comprising an exterior ring situated radially towards the exterior and an interior ring situated radially towards the interior, an exterior peripheral surface of the exterior ring a groove for a cable is formed and the interior ring for installation on a wheel pulley placed inside, the exterior ring having hardness greater than that of the interior ring, and the interior ring having resilience greater than that of the exterior ring, and the exterior ring being secured on the interior ring, in particular by adhesion, comprising a connection element.

However, with the solutions disclosed in these documents, improvement of the functions identified above, in particular the resistance to the mechanical attack of the traction cable, is not satisfactory. On the other hand, the rigidification of the device (lining) often gives rise to deterioration of the adhesion with the traction cable.

Consequently, there is a need for the device which is designed to form the device (lining) of the cable guide pulley, which withstands better the mechanical attack of the traction cable, while maintaining the adhesion with the traction cable.

A “radial direction/orientation” is a direction/orientation which is perpendicular to the axis of rotation of the cable guide pulley. This direction/orientation corresponds to the orientation of thickness of the device (lining).

An “axial direction/orientation” is a direction/orientation which is parallel to the axis of rotation of the cable guide pulley.

A “circumferential direction/orientation” is a direction/orientation which is tangent to any circle centred on the axis of rotation. This direction/orientation is perpendicular both to the axial direction/orientation and to the radial direction/orientation.

A “modulus MA10” is a traction stress (in MPa) for an elongation of ten percent (10%) at a temperature of 23° C. measured according to the standard ASTM D412.

An “elongation at break” is a value of deformation by elongation until breakage takes place determined on the basis of a traction measurement. The traction tests make it possible to determine the curves of the stresses/elongations and the properties at break. These tests are carried out according to the French standard NF T 46-002 of September 1988. The traction measurements are carried out at 60° C., and in normal conditions of humidity (50±10% relative humidity). The elongation at break is expressed in percentages.

An objective of the invention is thus to design a device which is designed to form a device (lining) of a cable guide pulley, and for this device (lining) to be able to provide an improvement in terms of resistance to the mechanical attack of the traction cable, while maintaining the adhesion with the traction cable.

The present invention concerns a device which is designed to form a device (lining) of a cable guide pulley, the device comprising an exterior face provided with a groove which is designed to be in contact with a cable, and an interior face which is designed to be in contact with a sole layer which would be in contact with the cable guide pulley, the device having a thickness (t), measured between the radially exterior end part of the exterior face, and the radially interior end part of the interior face at an axial centre of the device, the device comprising at least 2 volumes, i.e. an exterior volume which is exposed at the exterior face at least partly and contains the groove, and a main volume which is exposed at the interior face at least partly, the exterior volume and the main volume being made of different elastomer compositions, a modulus of elongation MA10 according to ASTM D 412 measured for an elongation of 10 percent and at a temperature of 23° C. of an elastomer composition constituting the exterior volume is lower than the modulus of elongation MA10 of an elastomer composition constituting the main volume, and a radial thickness (to) of the exterior volume measured at the axial centre of the groove is less than 0.5 times the thickness (t) of the device.

This structure provides an improvement in terms of resistance to the mechanical attack of the traction cable, while maintaining the adhesion with the traction cable.

Since the device comprises at least 2 volumes, the exterior volume which is exposed at the exterior face at least partly and contains the groove, and the main volume which is exposed at the interior face at least partly, and the modulus of elongation MA 10 according to ASTM D 412 measured for an elongation of 10 percent and at a temperature of 23° C. of the elastomer composition which constitutes the exterior volume, is lower than the modulus of elongation MA10 of the elastomer composition which constitutes the main volume, and the lower modulus MA10 has better characteristics in terms of elongation before break associated with greater resistance to fatigue for a given level of deformation.

Resistance to the mechanical attack of the traction cable is consequently possible.

Furthermore, the elastomer composition with the lower modulus MA10 has better properties of conveying the cable. Consequently, it is possible simultaneously to maintain and even improve the adhesion with the traction cable.

In addition, since the higher modulus MA10 of the elastomer composition constituting the main volume reduces the deformation of the device (lining) the main volume would be subjected to lesser fatigue. Resistance to the mechanical attack of the traction cable is consequently possible.

Since the radial thickness (to) of the exterior volume measured at the axial centre of the groove is less than 0.5 times the thickness (t) of the device, the device would be subjected globally to lower fatigue. Resistance to the mechanical attack of the traction cable is consequently possible.

According to another preferred embodiment, the radial thickness (to) of the exterior volume is more than 0.1 times the thickness (t) of the device.

If this thickness (to) of the exterior volume is less than, or equal to, 0.1 times the thickness (t) of the device, there is a risk that the volume of the exterior volume will become insufficient to withstand the fatigue caused by the deformation imposed by the traction cable. By establishing this radial thickness (to) of the exterior volume at a value higher than 0.1 times the thickness (t) of the device, resistance to the mechanical attack of the traction cable is possible, while maintaining the adhesion with the traction cable.

This radial thickness (to) of the exterior volume is preferably more than 0.15 times the thickness (t) of the device, even more preferably more than 0.2 times the thickness (t) of the device, still more preferably more than 0.25 times the thickness (t) of the device, and in particular, more than, or equal to, 0.3 times the thickness (t) of the device.

According to another preferred embodiment, the modulus of elongation MA10 of the elastomer composition which constitutes the main volume is at least 25% higher than the modulus of elongation MA 10 of the elastomer composition which constitutes the exterior volume.

If this modulus of elongation MA10 of the elastomer composition which constitutes the main volume is less than 25% higher than the modulus of elongation MA10 of the elastomer composition which constitutes the exterior volume, there is a risk that the reduction of the deformation at the main volume will become insufficient to undergo lower fatigue. By establishing this modulus of elongation MA10 of the elastomer composition which constitutes the main volume such that it is at least 25% higher than the modulus of elongation MA 10 of the elastomer composition which constitutes the exterior volume, resistance to the mechanical attack of the traction cable is possible.

This modulus of elongation MA10 of the elastomer composition which constitutes the main volume is preferably at least 30% higher than the modulus of elongation MA10 of the elastomer composition which constitutes the exterior volume, more preferably at least 35% higher than the modulus of elongation MA10 of the elastomer composition which constitutes the exterior volume, and still more preferably at least 40% higher than the modulus of elongation MA 10 of the elastomer composition which constitutes the exterior volume.

According to another preferred embodiment, the exterior volume is exposed at all of the exterior face.

With this structure, it is possible to produce the device easily and efficiently.

According to another preferred embodiment, the interior volume is exposed at all of the interior face.

With this structure, it is possible to produce the device easily and efficiently.

According to another preferred embodiment, the device also comprises an intermediate volume which is not exposed at the exterior face, and an elastomer composition which constitutes the intermediate volume is different both from the elastomer composition which constitutes the exterior volume and the elastomer composition which constitutes the main volume.

With this structure, efficient and effective resistance to the mechanical attack of the traction cable is possible, since it is possible to provide with a different function the elastomer composition which constitutes the intermediate volume, such as a low loss of energy in order to limit the overheating, or a modulus suitable for withstanding loads in order to limit the deformation of the device (lining).

According to another preferred embodiment, a modulus of elongation MA10 of an elastomer composition which constitutes the intermediate volume is lower than that of the elastomer composition which constitutes the main volume, and greater than that of the elastomer composition which constitutes the exterior volume.

With this structure, efficient and effective resistance to the mechanical attack of the traction cable is possible, since the intermediate volume can withstand loads in order to limit the deformation of the device (lining).

According to another preferred embodiment, the modulus of elongation MA10 of the elastomer composition which constitutes the intermediate volume is at least 20% lower than the modulus of elongation MA 10 of the elastomer composition which constitutes the main volume.

If this modulus of elongation MA10 of the elastomer composition which constitutes the intermediate volume is less than 20% lower than the modulus of elongation MA10 of the elastomer composition which constitutes the main volume, there is a risk that the intermediate volume will not be able to contribute satisfactorily to the resistance to the mechanical attack of the traction cable. By establishing this modulus of elongation MA10 of the elastomer composition which constitutes the intermediate volume such that it is at least 20% lower than the modulus of elongation MA10 of the elastomer composition which constitutes the main volume, efficient resistance to the mechanical attack of the traction cable is possible.

This modulus of elongation MA10 of the elastomer composition which constitutes the intermediate volume is preferably at least 25% lower than the modulus of elongation MA10 of the elastomer composition which constitutes the main volume, and more preferably at least 30% lower than the modulus of elongation MA10 of the elastomer composition which constitutes the main volume.

According to another preferred embodiment, the intermediate volume is exposed at the interior face at least partly, and the main volume is placed axially towards the exterior relative to the intermediate volume.

With this structure, efficient and effective resistance to the mechanical attack of the traction cable is possible, since it is possible to place the main volume where a material with a high modulus is the most appropriate for reducing the deformation of the device (lining).

According to another preferred embodiment, the main volume is placed axially towards the exterior both relative to the exterior volume and relative to the intermediate volume.

With this structure, the possibility of obtaining efficient and effective resistance to the mechanical attack of the traction cable is better, since it is possible to place the main volume where a material with a high modulus is the most appropriate for reducing the deformation of the device (lining).

According to another preferred embodiment, the main volume is exposed at the exterior face at least partly.

With this structure, the possibility of obtaining efficient and effective resistance to the mechanical attack of the traction cable is better still, since it is possible to place the main volume where a material with a high modulus is the most appropriate for reducing the deformation of the device (lining).

According to another preferred embodiment, the exterior volume is provided with an exterior volume reinforcement placed along an interior end periphery of the exterior volume, and such as to cover at least the interior end periphery of the exterior volume corresponding to the groove, with an elongation at break of an elastomer composition constituting the exterior volume reinforcement being at least equal to 200%, and a radial thickness (tor) measured at the axial centre of the groove being at the most equal to 0.1 times the thickness (t) of the device.

With this structure, it is possible to improve the resistance to wear and cracking of the device (lining), since the exterior volume reinforcement dissipates efficiently the energy transmitted by the traction cable as a result of the cyclical contact of the device (lining) with the traction cable.

If the elongation at break of the elastomer composition which constitutes the exterior volume reinforcement is less than 200%, there is risk that the dissipation of energy by this exterior volume reinforcement will become insufficient. By establishing this elongation at break of the elastomer composition which constitutes the exterior volume reinforcement such that it is at least 200%, it is possible to improve the resistance to wear and cracking of the device (lining).

This elongation at break of the elastomer composition which constitutes the exterior volume reinforcement is preferably at least 300%, more preferably at least 400%, and still more preferably at least 500%.

If the radial thickness (tor) measured at the axial centre of the groove is more than 0.1 times the thickness (t) of the device, there is a risk that dissipation of heat of the device will become insufficient, and that this will lead to deterioration of the service life of the device, since the rubber composition which constitutes this exterior volume reinforcement is dissipative. By establishing this radial thickness (tor) measured at the axial centre of the groove such that it is at most equal to 0.1 times the thickness (t) of the device, an improvement in terms of resistance to the mechanical fatigue of the device (lining) is possible.

With the structures described above, it is possible to obtain a device which is designed to form the device (lining) of the cable guide pulley, and this device (lining) can provide an improvement in terms of resistance to the mechanical attack of the traction cable, while maintaining the adhesion with the traction cable.

Other characteristics and advantages of the invention will become apparent from the following description provided with reference to the appended drawings, which illustrate the embodiment of the invention by way of non-limiting examples.

In these drawings:

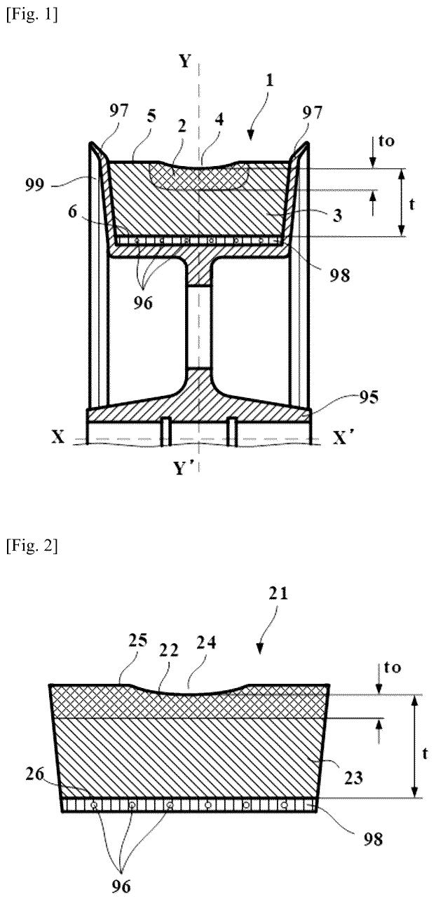

FIG. 1 is a schematic view in cross-section of a device with a cable guide pulley according to a first embodiment of the present invention;

FIG. 2 is a schematic view in cross-section of a device according to a second embodiment of the present invention;

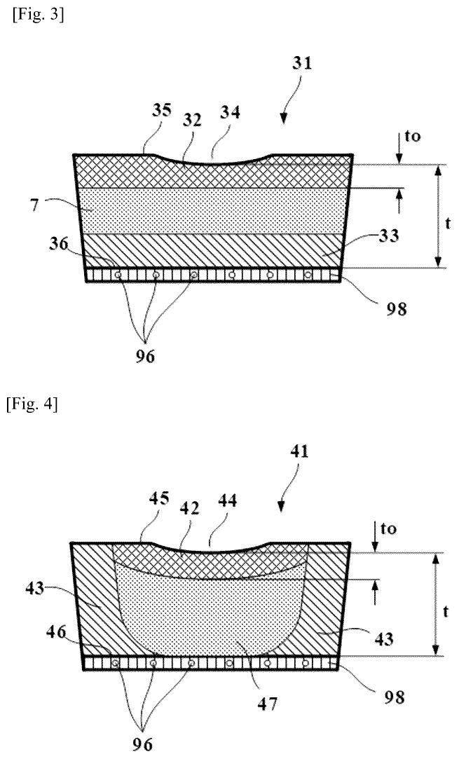

FIG. 3 is a schematic view in cross-section of a device according to a third embodiment of the present invention;

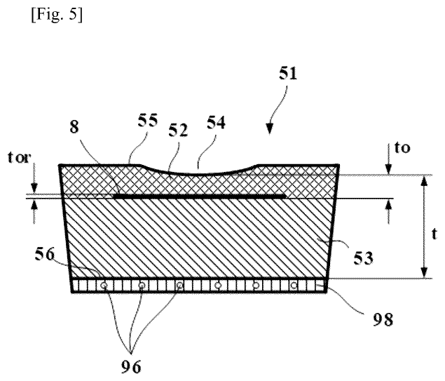

FIG. 4 is a schematic view in cross-section of a device according to a fourth embodiment of the present invention;

FIG. 5 is a schematic view in cross-section according to a fifth embodiment of the present invention.

Preferred embodiments of the present invention will be described below with reference to the drawings.

A device 1 according to a first embodiment of the present invention will be described with reference to FIG. 1.

FIG. 1 is a schematic view in cross-section of a device 1 with a cable guide pulley 99 according to a first embodiment of the present invention.

The cable guide pulley 99, with an axis of rotation XX′, comprises two axially spaced cheeks 97 defining an axial end of the cable guide pulley 99, and a hub 95 by means of which the cable guide pulley 99 is installed, such as to rotate, on a shaft secured along the axis of rotation XX′.

A device 1 is a device which is designed to form a lining for the cable guide pulley 99 at a part which is situated radially towards the exterior of the cable guide pulley 99 surrounded by two cheeks 97. The device 1 (lining) comprises an exterior face 5 provided with a groove 4, which is designed to be in contact with a cable (not illustrated) and an interior face 6, which is designed to be in contact with a sole layer 98 which would be in contact with the cable guide pulley 99. The sole layer 98 is reinforced by a plurality of sole reinforcements 96. An example of the sole reinforcement 96 is a cable, a wire, or a metal or textile sheet with straight or undulating strands, extending at an angle or not extending at an angle according to the circumferential orientation.

The device 1 (lining) has a thickness (t), measured between the radially exterior end part of the exterior face 5 and the radially interior end part of the interior face 6 at an axial centre of the device 1 (lining) indicated by YY′. In the present embodiment, the axial centre of the device 1 (lining) coincides with an axial centre of the groove 4.

The device 1 (lining) comprises 2 volumes, i.e. an exterior volume 2, which is exposed at the exterior face 5 at least partly, and contains the groove 4, and a main volume 3, which is exposed at the interior face 6 at least partly. The exterior volume 2 and the main volume 3 are made of different elastomer compositions.

A modulus of elongation MA10 according to ASTM D412, measured for an elongation of 10 percent (10%) and at a temperature of 23° C. of an elastomer composition constituting the exterior volume 2, is lower than the modulus of elongation MA10 of an elastomer composition constituting the main volume 3.

A radial thickness (to) of the exterior volume 2 measured at the axial centre of the groove 4 is less than 0.5 times the thickness (t) of the device 1 (lining).

The radial thickness (to) of the exterior volume 2 is more than 0.1 times the thickness (t) of the device 1 (lining). In the present embodiment, the thickness (to) of the exterior volume 2 is equal to 0.3 times the thickness (t) of the device 1 (lining).

The modulus of elongation MA10 of the elastomer composition which constitutes the main volume 3 is at least 25% higher than the modulus of elongation MA10 of the elastomer composition which constitutes the exterior volume 2. In the present embodiment, the modulus of elongation MA 10 of the elastomer composition which constitutes the exterior volume is 8 MPa, and the modulus of elongation MA10 of the elastomer composition which constitutes the main volume 3 is 10 MPa, i.e. 25% higher than that of the exterior volume 2.

The interior volume 3 is exposed at all of the interior face 6, and the main volume 3 is exposed at the exterior face 5 at least partly.

Since the device 1 (lining) comprises at least 2 volumes, i.e. the exterior volume 2 which is exposed at the exterior face 5 at least partly and contains the groove 4, and the main volume 3 which is exposed at the interior face 6 at least partly, and the modulus of elongation MA10 according to ASTM D412 measured for an elongation of 10 percent (10%) and at a temperature of 23° C. of the elastomer composition which constitutes the exterior volume 2, is lower than the modulus of elongation MA10 of the elastomer composition constituting the main volume 3, the lower modulus MA10 has better characteristics in terms of elongation before break, associated with greater resistance to fatigue for a given level of deformation. Resistance to the mechanical attack of the traction cable is consequently possible.

Furthermore, since the elastomer composition with the lower modulus MA10 has better properties of conveying the cable, it is possible simultaneously to maintain and even improve the adhesion with the traction cable.

In addition, since the higher modulus MA10 of the elastomer composition constituting the main volume 3 reduces the deformation of the device 1 (lining), the main volume 3 would be subjected to lesser fatigue. Resistance to the mechanical attack of the traction cable is consequently possible.

If the modulus of elongation MA10 of the exterior volume 2 is higher than the modulus of elongation MA10 of the main volume 3, the properties of conveying the cable by the device 1 (lining) become inappropriate, which gives rise to faster generation of cracks on the surface of the device 1 (lining).

Since the radial thickness (to) of the exterior volume 2 measured at the axial centre of the groove 4 is less than 0.5 times the thickness (t) of the device 1 (lining), the device 1 (lining) would be subjected globally to lesser fatigue.

Resistance to the mechanical attack of the traction cable is consequently possible.

Since the radial thickness (to) of the exterior volume 2 is more than 0.1 times the thickness (t) of the device 1 (lining), a resistance to the mechanical attack of the traction cable is possible, while maintaining the adhesion with the traction cable.

If this radial thickness (to) of the exterior volume 2 is equal to, or less than, 0.1 times the thickness (t) of the device 1 (lining), there is a risk that the volume of the exterior volume 2 will become insufficient to withstand the fatigue caused by the deformation imposed by the traction cable.

This radial thickness (to) of the exterior volume 2 is preferably more than 0.15 times the thickness (t) of the device 1 (lining), more preferably more than 0.2 times the thickness (t) of the device 1 (lining), still more preferably more than 0.25 times the thickness (t) of the device 1 (lining), and in particular more than 0.3 times the thickness (t) of the device 1 (lining).

Since the modulus of elongation MA10 of the elastomer composition which constitutes the main volume 3 is at least 25% higher than the modulus of elongation MA10 of the elastomer composition which constitutes the exterior volume 2, resistance to the mechanical attack of the traction cable is possible.

If this modulus of elongation MA10 of the elastomer composition which constitutes the main volume 3 is less than 25% higher than the modulus of elongation MA10 of the elastomer composition which constitutes the exterior volume 2, there is a risk that the reduction of the deformation at the main volume 3 will become insufficient to be subjected to lesser fatigue.

This modulus of elongation MA10 of the elastomer composition which constitutes the main volume 3 is preferably at least 30% higher than the modulus of elongation MA10 of the elastomer composition which constitutes the exterior volume 2, more preferably at least 35% higher than the modulus of elongation MA10 of the elastomer composition which constitutes the exterior volume 2, and even more preferably at least 40% higher than the modulus of elongation MA10 of the elastomer composition which constitutes the exterior volume 2.

A preferred modulus of elongation MA10 of the elastomer composition which constitutes the exterior volume 2 is equal to, or less than, 8.0 MPa, more preferably equal to, or less than 7.0 MPa, and still more preferably equal to, or less than 6.0 MPa.

A preferred modulus of elongation MA10 of the elastomer composition which constitutes the main volume 3 is equal to, or more than, 10.0 MPa, more preferably equal to, or more than, 12 MPa, and even more preferably equal to, or more than 14.0 MPa.

Since the interior volume 3 is exposed at all of the interior face 6, it is possible to produce the device 1 (lining) easily and efficiently.

Since the main volume 3 is exposed at the exterior face 5 at least partly, efficient and effective resistance to the mechanical attack of the traction cable is possible, since it is possible to place the main volume 3 where material with a high modulus is most appropriate for reducing the deformation of the device 1 (lining).

The device 1 (lining), the cable guide pulley 99, a contour of the exterior face 5, and the groove 4, can have any appropriate form, including one which is asymmetrical.

An interface between the exterior volume 2 and the main volume 3, between the main volume 3 and the sole layer 98, can have any form, for example straight, undulating, zigzagging, or conical.

The device 1 (lining) can be such that it is placed partly radially towards the exterior relative to the cheek 97.

The cable guide pulley 99 is preferably made of a material selected from among steel or alloys of aluminium and/or of magnesium, composite materials based on carbon fibre, glass fibre, aramid fibre, vegetable fibre, the said fibres being incorporated in a matrix based on thermosetting or thermoplastic compounds, or a complex compound comprising an elastomer and a complex compound based on resin and fibres selected from among carbon fibres, glass fibres, aramid fibres, vegetable fibres, or any combination of these materials.

The matrix based on thermosetting compounds is selected from among epoxy resins, vinylic ester, unsaturated polyesters, ester cyanate, bismaleimide, acrylic resins, phenolic resins, polyurethanes and their combinations.

The matrix based on thermoplastic compounds is selected from among polypropylene (PP), polyethylene (PE), polyamides (PA), semi-aromatic polyamides, polyester (PET) poly(butylene terephthalate) (PBT), polyetheretherketone (PEEK), polyetherketoneketone (PEKK), polyethersulphone (PSU), polyetherimide (PEI), polyimide (PI), polyamide-imide (PAI), poly(phenylene sulphide) (PPS), polyoxymethylene (POM), poly(phenylene oxide) (PPO).

The elastomer composition for the device 1 (lining) can be made of elastomers such as rubbers which can be cross-linked by chemical vulcanisation reactions by sulphur bridges, by carbon-carbon bonds created by the action of peroxides or ionising radiation, by other chains of specific atoms of the elastomer module, of thermoplastic elastomers (TPE) wherein the resiliently deformable part forms a network between relatively non-deformable “hard” regions, the cohesion of which is the product of physical bonds (crystallites or amorphous regions above their vitreous transition temperature), of non-thermoplastic elastomers, and of thermosetting resins.

A device 21 (lining) according to a second embodiment of the present invention will be described with reference FIG. 2. FIG. 2 is a view in schematic cross-section of a device according to a second embodiment of the present invention. The construction of this second embodiment is similar to that of the first embodiment, apart from the structure illustrated in FIG. 2, and the description will thus be provided with reference to FIG. 2.

As illustrated in FIG. 2, the device 21 (lining) comprises an exterior face 25 provided with a groove 24 which is designed to be in contact with a cable (not illustrated) and an interior face 26 which is designed to be in contact with a sole layer 98 which is reinforced with a plurality of sole reinforcements 96, and would be in contact with the cable guide pulley (not illustrated), with the device 21 (lining) having a thickness (t) measured between the radially exterior end part of the exterior face 25, and the radially interior end part of the interior face 26 at an axial centre of the device 21 (lining), the device 21 (lining) comprises 2 volumes, i.e. an exterior volume 22, which is entirely exposed at the exterior face 25 and contains the groove 24, and a main volume 23, which is entirely exposed at the interior face 26, with the exterior volume 22 and the main volume 23 being made of different elastomer compositions.

Since the exterior volume 22 and the main volume 23 are made of different elastomer compositions, a modulus of elongation MA10 according to ASTM D 412, measured for an elongation of 10 percent and at a temperature of 23° C. of an elastomer composition constituting the exterior volume 22, is lower than the modulus of elongation MA10 of an elastomer composition constituting the main volume 23.

As illustrated in FIG. 2, a radial thickness (to) of the exterior volume 22, measured at the axial centre of the groove 24, is less than 0.5 times the thickness (t) of the device 21 (lining).

As illustrated in FIG. 2, the exterior volume 22 is exposed at all of the exterior face 25.

Since the device 21 (lining) comprises at least 2 volumes, the exterior volume 22 which is exposed at the exterior face 25, and contains the groove 24, and the main volume 23 which is exposed at the interior face 26, and the modulus of elongation MA10 according to ASTM D412 measured for an elongation of 10 percent and at a temperature of 23° C. of the elastomer composition constituting the exterior volume 22, is lower than the modulus of elongation MA10 of the elastomer composition constituting the main volume 23, the lower modulus MA10 has better characteristics in terms of elongation before break, associated with greater resistance to fatigue for a given level of deformation. Resistance to the mechanical attack of the traction cable is consequently possible.

Furthermore, since the elastomer composition having the lower modulus MA10 has better properties of conveying the cable, it is possible simultaneously to maintain and even to improve the adhesion with the traction cable.

In addition, since the higher modulus MA10 of the elastomer composition constituting the main volume 23 reduces the deformation of the device 21 (lining), the main volume 23 would be subjected to lesser fatigue. Resistance to the mechanical attack of the traction cable is consequently possible.

Since the radial thickness (to) of the exterior volume 22 measured at the axial centre of the groove 24 is less than 0.5 times the thickness (t) of the device 21 (lining), the device (lining) would be subjected globally to lesser fatigue.

Resistance to the mechanical attack of the traction cable is consequently possible.

Since the exterior volume 22 is exposed at all of the exterior face 25, it is possible to produce the device 21 (lining) easily and efficiently.

An interface between the exterior volume 22 and the main volume 23, between the main volume 23 and the sole layer 98 can have any form, for example straight, undulating, zigzagging or conical.

A device 31 (lining) according to a third embodiment of the present invention will now be described with reference to FIG. 3. FIG. 3 is a view in schematic cross-section of a device according to a third embodiment of the present invention. The construction of this third embodiment is similar to that of the first and second embodiments, apart from the structure illustrated in FIG. 3, and the description will thus be provided with reference to FIG. 3.

As illustrated in FIG. 3, the device 31 (lining) comprises an exterior face 35 provided with a groove 34, which is designed to be in contact with a cable (not illustrated), and an interior face 36, which is designed to be in contact with a sole layer 98 which is reinforced with a plurality of sole reinforcements 96, and would be in contact with the cable guide pulley (not illustrated), the device 31 (lining) having a thickness (t) measured between the radially exterior end part of the exterior face 35, and the radially interior end part of the interior face 36 at an axial centre of the device 31 (lining), the device 31 (lining) comprises 3 volumes, i.e. an exterior volume 32 which is entirely exposed at the exterior face 35 and contains the groove 34, a main volume 33 which is entirely exposed at the interior face 36, and an intermediate volume 7 which is not exposed at the exterior face 35, the exterior volume 32, the main volume 33 and the intermediate volume 7 being made of different elastomer compositions. An interface between the exterior volume 32 and the intermediate volume 7, and an interface between the intermediate volume 7 and the main volume 33 both have a straight form.

Since the exterior volume 32 and the main volume 33 are made of different elastomer compositions, a modulus of elongation MA10 according to ASTM D 412, measured for an elongation of 10 percent and at a temperature of 23° C. of an elastomer composition constituting the exterior volume 32, is lower than the modulus of elongation MA10 of an elastomer composition constituting the main volume 33. A modulus of elongation MA10 of an elastomer composition which constitutes the intermediate volume 7 is lower than that of the elastomer composition which constitutes the main volume 33, and higher than that of the elastomer composition which constitutes the exterior volume 32. The modulus of elongation MA10 of the elastomer composition which constitutes the intermediate volume 7 is at least 20% lower than that of the modulus of elongation MA10 of the elastomer composition which constitutes the main volume 33. In the present embodiment, the modulus of elongation MA10 of the elastomer composition which constitutes the exterior volume is 6 MPa, and the modulus of elongation MA10 of the elastomer composition which constitutes the main volume 33 is 12 MPa, i.e. 100% higher than that of the exterior volume 32. The modulus of elongation MA10 of the elastomer composition which constitutes the intermediate volume 7 is 10 MPa, i.e. 20% lower than that of the main volume 33.

As illustrated in FIG. 3, a radial thickness (to) of the exterior volume 32 measured at the axial centre of the groove 34 is less than 0.5 times the thickness (t) of the device 31 (lining).

Since the device 31 (lining) also comprises the intermediate volume 7 which is not exposed at the exterior face 35, and an elastomer composition which constitutes the intermediate volume 7 is different both from the elastomer composition which constitutes the exterior volume 32 and the elastomer composition which constitutes the main volume 33, efficient and effective resistance to the mechanical attack of the traction cable is possible, since it is possible to provide with a different function the elastomer composition which constitutes the intermediate volume 7, such as a low loss of energy in order to limit the overheating, or a modulus which can withstand loads in order to limit the deformation of the device 31 (lining).

Since the modulus of elongation MA10 of the elastomer composition which constitutes the intermediate volume 7 is lower than that of the elastomer composition which constitutes the main volume 33, and higher than that of the elastomer composition which constitutes the exterior volume 32, efficient and effective resistance to the mechanical attack of the traction cable is possible, since the intermediate volume 7 can be able to withstand loads in order to limit the deformation of the device 31 (lining).

Since the modulus of elongation MA10 of the elastomer composition which constitutes the intermediate volume 7 is at least 20% lower than the modulus of elongation MA10 of the elastomer composition which constitutes the main volume 33, efficient resistance to the mechanical attack of the traction cable is possible.

If this modulus of elongation MA10 of the elastomer composition which constitutes the intermediate volume 7 is less than 20% lower than the modulus of elongation MA10 of the elastomer composition which constitutes the main volume 33, there is a risk that the intermediate volume 7 will not be able to contribute well to the resistance to the mechanical attack of the traction cable.

This modulus of elongation MA10 of the elastomer composition which constitutes the intermediate volume 7 is preferably at least 25% lower than the modulus of elongation MA10 of the elastomer composition which constitutes the main volume 33, and more preferably at least 30% lower than the modulus of elongation MA10 of the elastomer composition which constitutes the main volume 33.

A device 41 (lining) according to a fourth embodiment of the present invention will be described with reference to FIG. 4. FIG. 4 is a view in schematic cross-section of the device according to a fourth embodiment of the present invention. The construction of this fourth embodiment is similar to those of the first, second and third embodiments apart from the structure illustrated in FIG. 4, and the description will thus be provided with reference to FIG. 4.

As illustrated in FIG. 4, the device 41 (lining) comprises an exterior face 45 provided with a groove 44 which is designed to be in contact with a cable (not illustrated), and an interior face 46 which is designed to be in contact with a sole layer 98, which is reinforced with a plurality of sole reinforcements 96, and would be in contact with the cable guide pulley (not illustrated), the device 41 (lining) having a thickness (t) measured between the radially exterior end part of the exterior face 45 and the radially interior end part of the interior face 46 at an axial centre of the device 41 (lining), the device 41 (lining) comprises 3 volumes, i.e. an exterior volume 42 which is partly exposed at the exterior face 45 and contains the groove 44, a main volume 43 which is partly exposed at the interior face 46, and an intermediate volume 47, which is not exposed at the exterior face 45, the exterior volume 42, the main volume 43 and the intermediate volume 47 being made of different elastomer compositions.

As illustrated in FIG. 4, the intermediate volume 47 is exposed at the interior face 46 at least partly, and the main volume 43 is placed axially towards the exterior relative to the intermediate volume 47. In addition, the main volume 43 is placed axially towards the exterior both relative to the exterior volume 42 and relative to the intermediate volume 47, such as to surround the exterior volume 42 and the intermediate volume 47. The main volume 43 is exposed at the exterior face 45 at least partly. An interface between the exterior volume 42 and the intermediate volume 47 has a curved form, and an interface between the main volume 43 and both the exterior volume 42 and the intermediate volume 47 has a parabolic form.

As illustrated in FIG. 4, a radial thickness (to) of the exterior volume 42 measured at the axial centre of the groove 44 is less than 0.5 times the thickness (t) of the device 41 (lining).

Since the intermediate volume 47 is exposed at the interior face 46 at least partly, and the main volume 43 is placed axially towards the exterior relative to the intermediate volume 47, efficient and effective resistance to the mechanical attack of the traction cable is possible, since it is possible to place the main volume 43 where a material with a high modulus is the most appropriate in order to reduce the deformation of the device 41 (lining).

Since the main volume 43 is placed axially towards the exterior both relative to the exterior volume 42 and relative to the intermediate volume 47, the possibility of obtaining efficient and effective resistance to the mechanical attack of the traction cable is better, since it is possible to place the main volume 43 where a material with high modulus is the most appropriate for reducing the deformation of the device 41 (lining).

Since the main volume 43 is exposed at the exterior face 45 at least partly, the possibility of obtaining efficient and effective resistance to the mechanical attack of the traction cable is better still, since it is possible to place the main volume 43 where a material with a high modulus is the most appropriate for reducing the deformation of the device (lining).

A device 51 (lining) according to a fifth embodiment of the present invention will be described with reference to FIG. 5. FIG. 5 is a view in schematic cross-section of a device according to a fifth embodiment of the present invention. The construction of this fifth embodiment is similar to that of the first, second, third and fourth embodiments apart from the structure illustrated in FIG. 5, and the description will therefore be provided with reference to FIG. 5.

As illustrated in FIG. 5, the device 51 (lining) comprises an exterior face 55 provided with a groove 54 which is designed to be in contact with a cable (not illustrated) and an interior face 56 which is designed to be in contact with a sole layer 98 which is reinforced with a plurality of sole reinforcements 96, and would be in contact with the cable guide pulley (not illustrated), the device 51 (lining) having a thickness (t) measured between the radially exterior end part of the exterior face 55 and the radially interior end part of the interior face 56 at an axial centre of the device 51 (lining), the device 51 (lining) comprises 2 volumes, i.e. an exterior volume 52, which is entirely exposed at the exterior face 55 and contains the groove 54, and the main volume 53, which is entirely exposed at the interior face 56, the exterior volume 52 and a main volume 53 being made of different elastomer compositions.

As illustrated in FIG. 5, the exterior volume 52 is provided with an exterior volume reinforcement 8 which is placed along an interior end periphery of the exterior volume 52, and such as to cover at least the interior end periphery of the exterior volume 52 corresponding to the groove 54. An elongation at break of an elastomer composition constituting the exterior volume reinforcement 8 is at least equal to 200%.

As illustrated in FIG. 5, a radial thickness (tor) measured at the axial centre of the groove 54 is at the most equal to 0.1 times the thickness (t) of the device 51 (lining).

Since the exterior volume 52 is provided with the exterior volume reinforcement 8 placed along an interior end periphery of the exterior volume 52, and such as to cover at least the interior end periphery of the exterior volume 52 corresponding to the groove 54, and the elongation at break of an elastomer composition constituting the exterior volume reinforcement 8 is at least equal to 200%, it is possible to improve the resistance to wear and cracking of the device 51 (lining), since the exterior volume reinforcement 8 dissipates efficiently the energy transmitted by the traction cable, as a result of the cyclical contact of the device 51 (lining) with the traction cable.

If the elongation at break of the elastomer composition which constitutes the exterior volume reinforcement 8 is less than 200%, there is a risk that the dissipation of energy by this exterior volume reinforcement 8 will become insufficient. By establishing this elongation at break of the elastomer composition which constitutes the exterior volume reinforcement 8 such that it is at least 200%, it is possible to improve the resistance to wear and cracking of the device 51 (lining).

This elongation at break of the elastomer composition which constitutes the exterior volume reinforcement 8 is preferably at least 300%, more preferably at least 400%, and even more preferably at least 500%.

If the radial thickness (tor) measured at the axial centre of the groove 54 is more than 0.1 times the thickness (t) of the device 51 (lining), there is a risk that dissipation of heat of the device 51 (lining) will become insufficient, and that this will lead to deterioration of the service life of the device 51 (lining), since the rubber composition which constitutes this exterior volume reinforcement 8 is dissipative. By establishing this radial thickness (tor) measured at the axial centre of the groove 54 such that it is at the most equal to 0.1 times the thickness (t) of the device 51 (lining), an improvement in terms of resistance to the mechanical fatigue of the device 51 (lining) is possible.

The exterior volume reinforcement 8 can be placed along all of the interior end periphery of the exterior volume 82, or it can extend as far as a periphery of any other volume in contact with the exterior volume 52. The exterior volume reinforcement 8 can, axially from one end to the other end, be at a constant radial distance from the exterior face 55, or it can, axially from one end to the other end, be at a variable radial distance from the exterior face 55.

The thickness (tor) of the exterior volume reinforcement can vary in its axial orientation, or it can have a minimal value of 1.0 mm.

The invention is not limited to the examples described and represented, and various modifications can be made without departing from its scope.

### LIST OF THE REFERENCE SIGNS

1, 21, 31, 41, 51 device
2, 22, 32, 42, 52 exterior volume
3, 23, 33, 43, 53 main volume
4, 24, 34, 44, 54 groove
5, 25, 35, 45, 55 exterior face
6, 26, 36, 46, 56 interior face
7, 47 intermediate volume
8 exterior volume reinforcement
95 hub
96 sole reinforcement
97 cheek
98 sole layer
99 cable guide pulley

1. A device which is designed to form a lining of a cable guide pulley, the device comprising an exterior face provided with a groove which is designed to be in contact with a cable, and an interior face which is designed to be in contact with a sole layer which would be in contact with the cable guide pulley, the device having a thickness (t), measured between the radially exterior end part of the exterior face, and the radially interior end part of the interior face at an axial centre of the device, the device comprising at least 2 volumes,
consisting of an exterior volume which is exposed at the exterior faceat least partly and contains the groove, and a main volume which is exposed at the interior face at least partly, the exterior volume and the main volume being made of different elastomer compositions,
a modulus of elongation MA10 according to ASTM D 412 measured for an elongation of 10 percent and at a temperature of 23° C. of an elastomer composition constituting the exterior volume being lower than the modulus of elongation MA10 of an elastomer composition constituting the main volume,
a radial thickness of of the exterior volume measured at the axial centre of the groove being less than 0.5 times the thickness (t) of the device, the device further comprising an intermediate volume which is not exposed at the exterior face, the intermediate volume made of an intermediate volume elastomer composition which is different from the elastomer composition which constitutes the exterior volume and the elastomer composition which constitutes the main volume.

2. The device according to claim 1, wherein the radial thickness of the exterior volume is more than 0.1 times the thickness (t) of the device.

3. The device according to claim 1, wherein the modulus of elongation MA10 of the elastomer composition which constitutes the main volume is at least 25% higher than the modulus of elongation MA10 of the elastomer composition which constitutes the exterior volume

4. The device according to claim 1, the exterior volume is exposed at all of the exterior face

5. The device according to claim 1, wherein the interior volume is exposed at all of the interior face.

6. The device according to claim 1, wherein a modulus of elongation MA10 of an elastomer composition which constitutes the intermediate volume is lower than that of the elastomer composition which constitutes the main volume and higher than that of the elastomer composition which constitutes the exterior volume.

7. The device according to claim 6, wherein the modulus of elongation MA10 of the elastomer composition which constitutes the intermediate volume is at least 20% lower than the modulus of elongation MA10 of the elastomer composition which constitutes the main volume.

8. The device according to claim 6, wherein the intermediate volume is exposed at the interior face at least partly, and wherein the main volume is placed axially towards the exterior relative to the intermediate volume.

9. The device according to claim 8, wherein the main volume is placed axially towards the exterior both relative to the exterior volume and relative to the intermediate volume.

10. The device according to claim 8, wherein the main volume is exposed at the exterior face at least partly.

11. The device according to claim 1, the exterior volume is provided with an exterior volume reinforcement placed along an interior end periphery of the exterior volume, and such as to cover at least the interior end periphery of the exterior volume corresponding to the groove and wherein an elongation at break of an elastomer composition constituting the exterior volume reinforcement at least equal to 200%, and wherein a radial thickness measured at the axial centre of the groove at the most equal to 0.1 times the thickness (t) of the device.
